(19) United States
(12) Patent Application Publication
(10) Pub. No.: US 2013/0211608 A1
(43) Pub. Date: Aug. 15, 2013

(54) SYSTEMS AND METHODS FOR REMOTELY POWERING, CONFIGURING AND CONTROLLING DC POWERED MULTI-CHANNEL DEVICES

(71) Applicants: Richard C. Farrell, Newport Beach, CA (US); Bobby D. Taylor, Costa Mesa, CA (US)

(72) Inventors: Richard C. Farrell, Newport Beach, CA (US); Eduardo Bertagni, Tustin, CA (US); Bobby D. Taylor, Costa Mesa, CA (US)

(21) Appl. No.: 13/764,730

(22) Filed: Feb. 11, 2013

Related U.S. Application Data
(60) Provisional application No. 61/597,662, filed on Feb. 10, 2012.

(51) Int. Cl. G06F 1/26

(52) U.S. Cl. CPC G06F 1/26
USPC 700/286

(57) ABSTRACT

A centralized multi-channel power control system for configuring, programming and controlling DC powered devices, such as lights, having multiple sets of LEDs energized through multiple channels is provided. The devices may be located in multiple zones of a structure and operate as a single integrated circuit or series of electronic devices instead of a series of lights connected directly to AC power. The control system comprises power control module(s) connected to a power distribution module. The power control module(s) may include a memory device having pre-set applications for controlling the devices and an embedded microprocessor for individually managing a single zone in the multiple zone system. The power control module(s) may control and dim multiple separate channels which can be individually controlled or intermixed to create a variety of lighting color schemes. The system thus creates a DC network or micro-grid for configuring; programming and controlling of DC powered devices.

### CLAIM OF PRIORITY UNDER 35 U.S.C. §119

The present Application for Patent claims priority to Provisional Application No. 61/532,546 entitled “Lighting Technology System and Method” filed Feb. 10, 2012 and is hereby expressly incorporated by reference herein.

### FIELD

Aspects of the present disclosure relate generally to a centralized multi-channel control system for configuring, programming and controlling multi-channel DC powered devices located in multiple zones. The multiple zones may be located in one or more physical locations, such as a structure.

### BACKGROUND

Industry has powered traditional lighting fixtures (fixtures), office and personal electronics using alternating current to each fixture or device for decades and continues the same practice today with LED fixtures and DC powered devices, such as office equipment and/or personal electronics. These fixtures or devices contain power supplies that convert alternating current to direct current to power the illumination source or device; however, there are many limitations with this practice. Some of these limitations include; the required use of metal conduit in commercial installations, having to use heavy gauge wiring, having to run a ground wire with AC power, expensive and complex circuitry for dimming and control, added expense of multiple power supplies, increased hazard of using Class 1 power, increased hazard of using multiple power supplies and control circuitry, larger more expensive fixtures and/or DC powered devices.

Furthermore, typical lighting control systems utilize a decentralized multi-channel command approach for controlling fixtures which can result is increased network traffic and system latency when multiple users are accessing the system at the same time.

What is needed is a centralized power and control system that allows DC powered devices, such as LED lighting, office equipment and personal devices, to be configured and controlled as if a structure, such as a building, was one large integrated lighting circuit and not a multiple of DC powered devices connected to AC power.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspect of the disclosure. Its sole purpose is to present some concepts of one or more aspects of the disclosure in a simplified form as a prelude to the more detailed description that is presented later.

In one aspect, the disclosure provides a multi-channel power control system. The system may include a power distribution module having a power supply module, such as a class 1 or a class 2 power supply, for converting alternating current into direct current; and a current limiter-dimming module for receiving and restricting the direct current output of the power supply module. The system may further include one or more fixtures having at least a first set of LEDs energized through a first channel and a second set of LEDs energized through a second channel; and one or more power control modules powered by the power distribution module. The fixtures may also include more than two sets of channels. Each power control module in the one or more power control modules may comprise a memory device for storing pre-set applications for controlling the one or more fixtures; and a processor, coupled to the memory device, and configured to individually control the first and second channels of the one or more fixtures and receive data from one or more sensors connected to the one or more power control modules, the sensor data used to adjust the one or more fixtures and generate an environmental report for energy usage. The one or more sensors includes at least one of an occupancy sensor, a daylight sensor, a biometric feedback sensor, a security sensor, and an environmental sensor, wherein the environmental sensor includes at least of a temperature sensor, an O₂ sensor, a CO₂ sensor, a sound level sensor, an audio input sensor.

The processor in each power control module may be connected to a multi-channel dimmer which may be configured for individually dimming each channel in the one or more fixtures. The multi-channel dimmer may include a plurality of dimming control modules for controlling each channel in the one or more fixtures.

The one or more power control modules may further include a third set of LEDs energized through a third channel and a fourth set of LEDs energized through a fourth channel; wherein the first set of LEDs radiates light at a first color temperature, the second set of LEDs radiates light at a second color temperature, the third set of LEDs radiates light at a third color temperature and the fourth set of LEDs radiates light at a fourth color temperature, where the first color temperature, the second color temperature the third color temperature and the fourth color temperature are different colors. Additionally, the one or more power control modules may dim and mix colors of each channel of LEDs in the one or more fixtures.

The multi-channel power control system may further include a wireless control module communicatively coupled to the one or more power control modules and/or the power distribution module; and a user controller, wirelessly connected to the wireless control module, configured to adjust settings on the one or more fixtures; program applications for controlling the power control system; receive data from one or more sensors connected to the one or more power control modules; and generate environmental reports for monitoring energy usage.

In another aspect, the disclosure provides a multi-channel power control system. The system may comprise a power supply module for converting alternating current into direct current; a current limiter module for receiving and restricting the direct current output of the power supply module; one or more fixtures connected to the current limiter module, the fixture having at least a first set of LEDs energized through at least a first channel and a second set of LEDs energized through a second channel; and a power control module, the current limiter module connected between the power supply module and the power control module. The power control module may comprise a memory device; and a processor, coupled to the memory device, configured to individually control the first and second channels of the one or more fixtures; a multi-channel dimmer module, in communication with the processor, having a plurality of dimming control modules for individually controlling each channel in each fixture; and one or more sensors, in communication with the processor, configured for adjusting the fixture.

In yet another aspect, the disclosure provides a multi-channel power control system. The system may include a power supply module for converting alternating current into direct current; a current limiter module for receiving and restricting the direct current output of the power supply module; one or more DC powered devices connected to the current limiter module, the one or more DC powered devices having at least a first channel and a second channel for providing DC power; and a power control module, the current limiter module connected between the power supply module and the power control module. The power control module may comprise a memory device; and a processor, coupled to the memory device, configured to individually control the first and second channels of the one or more DC powered devices.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating an example of a hardware implementation for an apparatus employing a processing system.

FIG. 2 illustrates a multi-channel control system according to one example.

FIG. 3 illustrates an external frontal plate of a multi-channel wall dimmer according to one example.

FIG. 4 illustrates a multi-channel control system according to one example.

FIG. 5 is a block diagram illustrating a power control module for configuring, programming and controlling multi-channel DC powered devices in multiple zones of power.

FIG. 6 is a block diagram illustrating a power distribution module for providing power to one or more power control modules for powering multi-channel DC powered devices.

FIG. 7 illustrates a multi-channel light engine having a checkerboard pattern.

FIG. 8 illustrates an exploded view of a four color illuminating device according to one example.

FIG. 9 illustrates an exploded view of a four color illuminating device according to one example.

FIG. 10 illustrates an exploded view of a four color illuminating device according to one example.

FIG. 11 illustrates a partial view of a pattern for a LED panel according to one example.

FIG. 12A illustrates an audio enabled illuminating device according to one example.

FIG. 12B illustrates a top plan view of the audio enabled illuminating device of FIG. 12A.

FIG. 12C illustrates a cross-sectional view taken along line A-A of FIG. 12B.

FIG. 12D illustrates an enlarged view of Detail B of FIG. 12C.

FIG. 13A illustrates an audio enabled illuminating device according to one example.

FIG. 13B illustrates a side plan view of the audio enabled illuminating device of FIG. 13A.

FIG. 13C illustrates a side view of the audio enabled illuminating device of FIG. 13A.

FIG. 14 illustrates an audio module according to one example.

FIG. 15 illustrates a screen shot of a program for providing wireless access to the configuration, management and control features of a centralized power and control system for DC powered devices, according to one example.

FIG. 16A illustrates a screen shot of a sound setup screen.

FIG. 16B illustrates a screen shot of a sounds library screen.

FIG. 17 illustrates a screen shot of a program for providing wireless access to the configuration, management and control features of a centralized power and control system for DC powered devices, according to one example.

FIG. 18 illustrates an example of an energy monitoring panel according to one example.

FIG. 19 illustrates an example of an energy monitoring panel according to one example.

FIG. 20 illustrates an injection molded front lens.

FIG. 21 illustrates a heat-formed frontal lens manufacturing method.

FIG. 22 illustrates an exploded view of a two-layer FR-4 engine attached to frontal lens with a bonding agent and no Rear Bather.

### DETAILED DESCRIPTION OF THE INVENTION

In the following detailed description, numerous specific details are set forth in order to provide a thorough understanding of the embodiments. However, it will be understood by one of ordinary skill in the art that the embodiments may be practiced without these specific details. For example, well-known operations, structures and techniques may not be shown in detail in order not to obscure the embodiments.

The word “exemplary” is used herein to mean “serving as an example, instance, or illustration.” Any implementation or embodiment described herein as “exemplary” is not necessarily to be construed as preferred or advantageous over other embodiments. Likewise, the term “embodiments” does not require that all embodiments include the discussed feature, advantage or mode of operation.

While the present disclosure is described primarily with respect to fixtures or illuminating devices, the present disclosure may be applied and adapted to various applications. The present disclosure may be applied to any DC powered device, such as office equipment, personal electronics and where there is a need for a centralized power and control system that allows DC powered devices to be configured and controlled as if a structure was one large integrated lighting/device circuit and not a multiple of DC powered devices connected to AC power.

In the following description, certain terminology is used to describe certain features of one or more embodiments. The terms “DC powered device” may refer to any type of multi-channel device powered by DC voltage, including but not limited to, fixtures, illuminating devices, office equipment (for example, servers, computers, printers and telephone systems) and personal equipment (for example, mobile phones, televisions and appliances). The term “channel” may refer to a (2 wire) circuit capable of delivering (24V) DC power from a power source (whether local or remote) to a DC powered device. The term “zone” may refer to a physical, three-dimensional space, such as a room, in which one or more channels are brought into, in order to power one or more fixtures or devices. According to one aspect, a “space” may contain not only multiple channels but multiple zones as well. For example, a “space” may be a conference room that includes a first zone controlling overhead light fixtures in the conference room, a second zone controlling spotlights around the periphery of the conference room, a third zone controlling wall washers to illuminate artwork and a fourth zone powering and controlling DC powered office and personal electronics. The term “department” may refer to a group of zones within a building or structure that are common to a certain type of activity or share a common denomination, such as a sales department. The term “bank” may refer to an array of power distribution modules. According to one aspect, each bank may include up to 48 Channels and up to 48 Zones, the entire bank may comprise a single zone or any combination in between. The term “mobile device” or “mobile phone” may refer to a handheld device, a wireless device, a mobile communication device, a user communication device, personal digital assistant, mobile palm-held computer, a laptop computer, remote control and/or other types of mobile devices typically carried by individuals and/or having some form of communication capabilities (e.g., wireless, infrared, short-range radio, etc.).

### Overview

According to one aspect, a centralized multi-channel power control system for configuring, programming and controlling multi-channel DC devices, such as illumination devices having multiple sets of LEDs energized through multiple channels, is provided. The DC powered devices may be located in multiple zones of a structure, such as a building, and operate as a single integrated power circuit instead of a series of devices connected to AC power. The centralized multi-channel power control system may be comprised of one or more power control modules connected to and in communication with a power distribution module. Each of the power control modules may include a memory device having pre-set applications for controlling the operation of the DC powered devices and an embedded microprocessor (or “processor”) for individually managing a single zone in the multiple zone system.

According to one aspect, each power control module may control two or more separate channels. For example, each power control module may control and dim two or more separate channels of an illuminating devices. In another example, the channels may be connected to dual-color and tunable-white light fixtures or illuminators, or multi-color light fixtures or illuminators. The channels can be individually controlled or fully intermixed to create a variety of color schemes suited for diverse applications within commercial, residential and healthcare applications.

The centralized multi-channel power control system of the present disclosure can be adapted to an array of DC powered devices, such as third-party illumination, display devices, office equipment and personal electronics, and for use in multiple applications such as commercial, industrial, residential, healthcare, retail, educational, and the like.

According to one embodiment, the power supply module, the current limiter dimming module and power control modules are placed remotely from the DC powered devices. As such, none of these modules are required to be located within the DC powered devices. The supply module, the current limiter dimming module and power control modules being located in a single unit instead of multiple units on each DC powered device makes the power, configuration and control of the DC powered devices simpler and more cost effective.

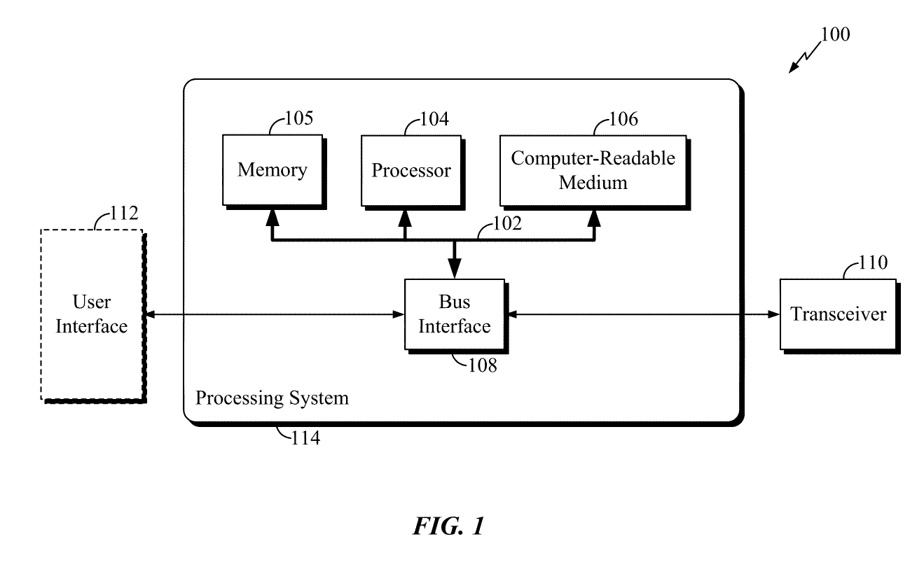

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus-architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, current limiter circuitry and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Multi-Channel Power Control System

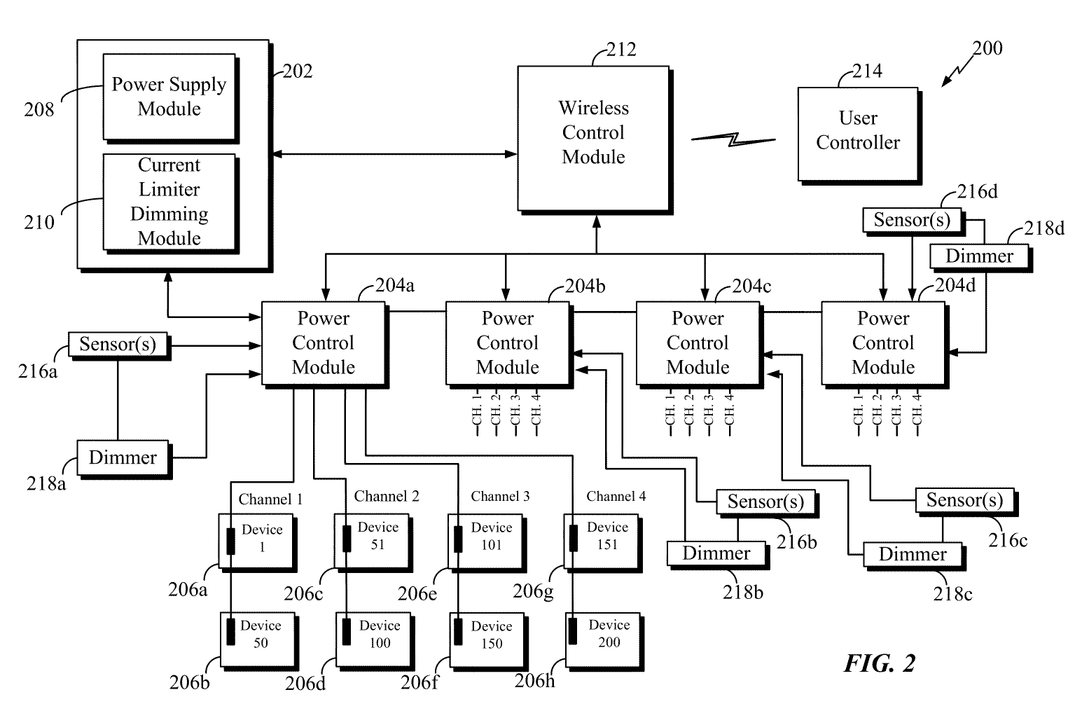

FIG. 2 illustrates a centralized multi-channel power control system 200 according to one example. As shown, a power distribution module 202 may be communicatively coupled, or connected to, one or more power control modules 204a-204d. Although four (4) power control modules are shown, this is by way of example only and the system may have more than four (4) power control modules or fewer than four (4) power control modules. Each of the power control modules 204a-204d may control one or more DC powered devices 206a-206h having multiple channels (channels 1-4) located in a single zone of a multi-zone structure. Alternatively, each of the power control modules 204a-204d may control a space containing multiple channels as well as multiple zones.

As described in further detail below, the power distribution module 202 may comprise a power supply module 208 and a current limiter dimming module 210 for limiting the current supplied to the one or more power control modules as well as any internal control modules located within the DC powered devices. According to one aspect, the power distribution module 202 and the power control modules 204a-204d may be wired or wirelessly controlled. The centralized multi-channel power control system may further include a wireless control module 212 for wireless controlling the power distribution module 202 and/or the power control modules. A user controller 214 may be wired or wirelessly connected to the wireless control module 212. The user controller 214 may be an external device, such as a computer or mobile device, allowing a user to remotely configure, program and control the one or more DC powered devices.

Each power control module 204a-204d may be connected to and receive data from one or more sensors 216a-216d. The sensors 216a-216d may include, but are not limited to, a motion/tilt sensor, an object detection sensor, a proximity/range sensor, a voice activated sensor, a biometric feedback sensor, an acceleration sensor, an ultrasonic sensor, an acoustic sensor, a temperature sensor, a thermocouple sensor, a tactile sensor, a moisture/humidity sensor, a capacitive sensor, an inductive loop sensor, a pressure/force sensor, a compression sensor, a seismic sensor, a vibration sensor, a barometric sensor, a CO₂ sensor, a gas sensor, an oxygen sensor, a smoke sensor, a flame sensor, a magnetic sensor, a rain/tide sensor, a water/flow sensor, a radiation sensor and an infrared—UV sensor.

Some of the above-listed sensors are commonly used in the lighting industry and directly related to use with light fixtures while other sensors are not commonly used in the lighting industry and are non-related to use with light fixtures or illuminating devices. The directly related sensors can trigger a visual cue such as color temperature change, luminous intensity change, and the like. With non-related sensors, the processor in each power control module may receive and process the incoming data from the non-related sensors attached to the power control module and relay the received and processed data to another device or control, which can then perform an action. For example, although a proximity sensor may not change the state of illumination of a fixture in a particular room or zone, data received from the proximity sensor may be processed and sent to another device, component and/or system that controls other devices, such as an electronic relay that opens and closes a door. It may also determine that the data is to be stored and analyzed for other purposes such as building traffic analysis, energy usage analysis, building space allocation, insurance cost analysis, environmental optimization, safety analysis, and other commercial or personal uses as may be found necessary to improve occupants comfort safety and efficiency or financial optimization of a building facility, campus or residence.

According to one embodiment, non-related sensors may trigger direct and indirect events at the same time. For example, when the proximity sensor senses someone, data may be sent to the door-opening relay and cause the processor in the lighting control module to increase the illumination level of a fixture, such as from 50% to 100%, as the user walks through the door.

Furthermore, each power control module may include the processing power and multiple input/output capabilities, enabling for the connection of a sensor (other than occupancy or daylight harvesting) in a particular zone (i.e. an open-plan office) that can collect specific information on that zone (i.e.: temperature) and subsequently interpret, process and relay such data to another device (such as HVAC central control or a third-party control of motorized shades or windows). Having control and monitoring of lighting and HVAC equipment in today's commercial and industrial buildings is a desired feature due to the “greening potential” available by reducing energy consumption, eliminating energy waste and reducing CO₂ emissions which in turn results in the reduction in operational costs.

According to one embodiment, each power control module 204a-204d may be capable of receiving analog data from a dimmer 218a-218d, for example an Industry Standard 0-10V dimmer, and then convert and process the data in the digital domain. The dimmers 218a-218d may be coupled to the sensors 216a-216d. The power control module may also be capable of receiving analog data from rotary/slide dimmers, touchless dimmers, wireless dimmers, audible control and multi-channel dimmers. By converting and processing the data in the digital domain, an additional set of features related to Pulse Width Modulation (PWM) and phase or frequency shifting dimming may be utilized.

According to one example, dimming steps from 0 (or full OFF) to 100 (or full ON) can be software-adjusted anywhere between 1 and 1023 points. This defines the “smoothness” (resolution) of the light output on an LED-based fixture as it goes from its minimum dim level to fully ON. If a particular application requires a pre-set amount of dimming steps (i.e. ten steps) the software driving the processor can then set those steps as the analog dimmer reaches a specific output voltage, for example: 1V=10% dim, 2V=20% dim and so on. If a particular application requires non-linear dimming, the software driving the processor can convert the 0-10 input voltage to the desired dimming steps using inherent trigonometric or logarithmic functions. For example, if a particular application requires the fixture(s) in a zone to be pre-set at a maximum light output (due to desired illumination levels or to comply with a watt-per-ft² requirement) the processor can be adjusted so the analog dimmer still has full range of mechanical travel, yet the light output at its maximum setting is not 100% ON (i.e.: set the max. dimmer range to output 75% of power).

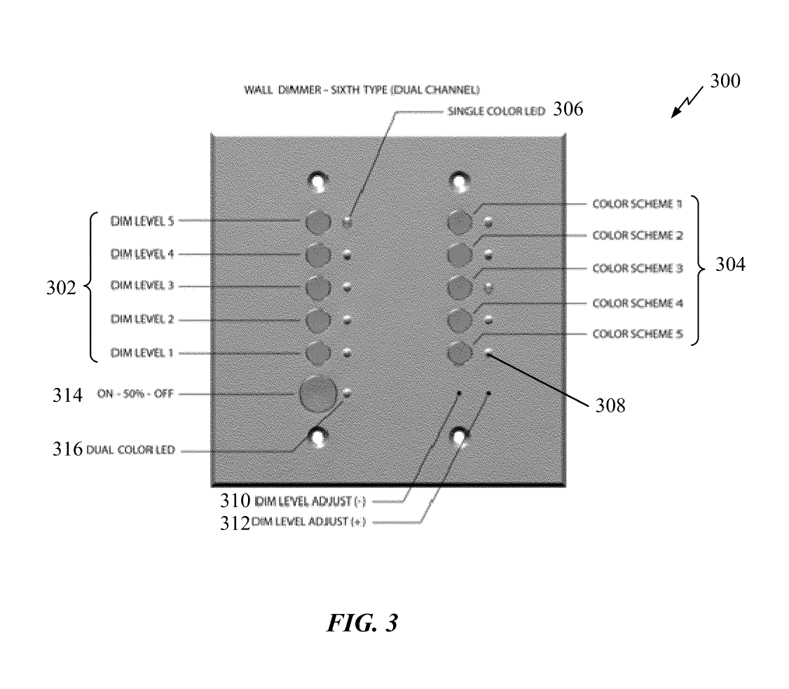

FIG. 3 illustrates an external frontal plate of a multi-channel wall dimmer according to one example. Although two channels are shown, this is by way of example and the multi-channel dimmer can have more than two channels. The external frontal plate may be designed to be mounted on a standard wall/partition. The rear portion of the wall dimmer (containing electronics and I/O connectors) may be designed to fit inside a standard 2 or multiple-gang electrical box or a 2 or multiple-gang low-voltage plastic trim ring. The external frontal plate may be larger than the wall opening so as to cover the wall opening plus any irregularities around such opening.

As shown, the multi-channel wall dimmer 300 may include a first set of vertically aligned buttons 302 and a second set of vertically aligned buttons 304. A first set of LEDS may be horizontally aligned with the first set of vertically aligned buttons 302 were each button has a corresponding LED and a first set of LEDS 308 may be horizontally aligned with the second set of vertically aligned buttons 304 were each button has a corresponding LED. The LEDs may be used as an indication or visual confirmation of the “active” or most recently pushed button. According to one embodiment, one LED in each set of LEDs may be turned ON at a single time.

The first set of buttons 302 enable an end user to select five-levels of illumination dimming, whereas such may be pre-set (i.e.: factory preset in 20% increments) yet the dimming level of each button can be field-adjustable by the end user to any dimming preference between 1% and 100%. The field-adjustability may be accomplished by inserting a small tool or a paper-clip end through one of two small openings in the frontal plate, whereas the left opening 310 may be to lower the dim level while the right opening 312 may be used to raise the dim level.

The second set of buttons 304 may be factory pre-set to five color schemes that are not field-adjustable. According to one embodiment, the first color scheme may be Ultra-Warm White, the second color scheme may be Warm White, the third color scheme may be Neutral White, the fourth color scheme may be Cool White and the fifth color scheme may be Ultra-Cool White. The end user can adjust the desired color scheme as well as the dimming level of such color scheme. The color scheme may be determined by the type of dual-color light fixture connected to a dimmer in a particular room or zone. Other color schemes, such as Blue-Green, Amber-Blue, etc. are feasible.

According to one embodiment, the wall dimmer may be configured such that the top button is an indication that the illuminated device is 100% ON, the second button is an indication that the illuminated device is 80%, third button is an indication is that the illuminated device is 60%, the fourth button is an indication that the illuminated device is 40% and the fifth button is an indication that the illuminated device is 20%.

According to one embodiment, a 3-way button 314 may be located below the first set of buttons 302. The 3-way button may enable three progress illumination states: ON, 50% and OFF, where the 50% state can be used to emulate Title 24 Code requirements of bi-level switching. Bi-level switching may be defined as the manual or automatic control (or a combination thereof) that provides two levels of lighting power in a space (not including off). In one embodiment, one LED 316 may be aligned with the 3-way button 314 and produce two colors, where one color (i.e. amber) indicates 50% off and another color (i.e. red) indicates the dimmer is in the OFF state. Alternatively, the 3-way button may be used as a field-reset button where pressing and holding down the button 316 for a predetermined amount of time (i.e. 5 seconds) re-sets the five dimming level buttons to the original factory pre-set configuration.

### Multi-Channel Lighting Control System

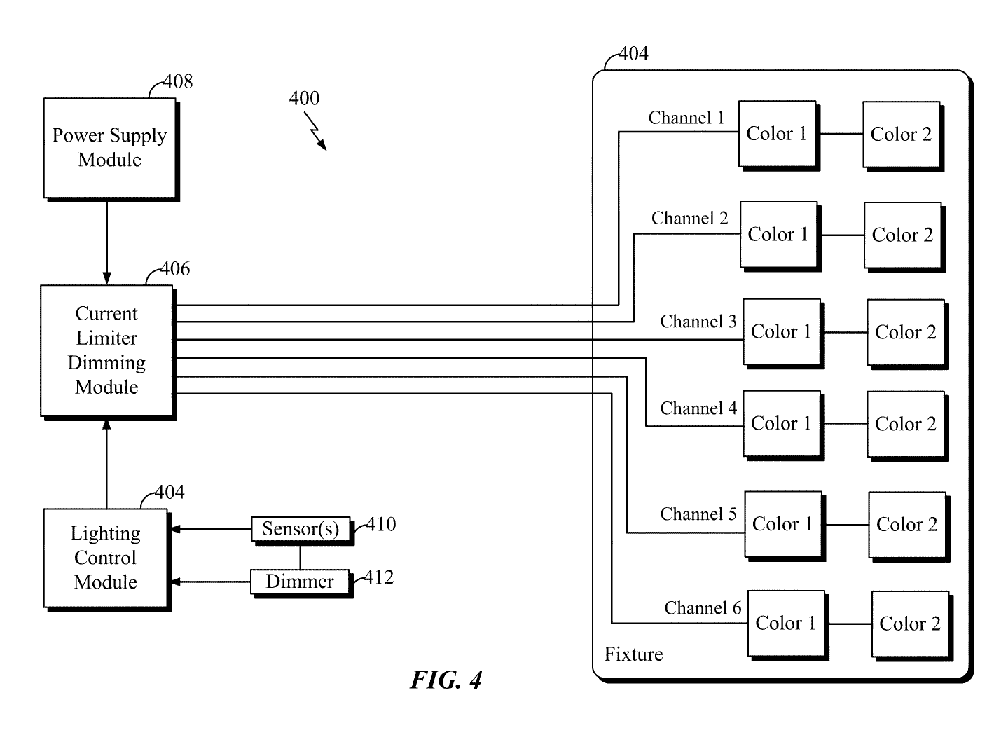

FIG. 4 illustrates a multi-channel lighting control system 300 according to one example. As shown, a lighting control module 402 may control multiple channels of LEDS within a fixture 404. Each channel may include a set of LEDS which are energized through the channel. The set of LEDs may include a plurality of colors (Color 1, Color 2 and so forth). In turn, the lighting control module 402 may control and dim two or more separate channels connected to dual-color (Color 1, Color 2 and so forth) and tunable-white light fixtures and illuminators. The channels can be individually controlled or fully intermixed to create a variety of color schemes suited for diverse applications within commercial, residential and healthcare applications. A memory device in the lighting control module may include pre-set functions and/or algorithms for controlling the fixtures and an embedded processor for individually managing a single zone in the multiple zone system.

A current limiter module 406 may be connected between a power supply module 408 and the lighting control module 402. The power supply module 408 may convert alternating current into direct current which is supplied to the lighting control module 402 via the current limiter module 406 which receives and restricts the direct current output from the power supply module 408.

The lighting control module 402 may be connected to and receive data from one or more sensors 410 and dimmers 412. The dimmer 412 may be coupled to the sensor 410. As described above with reference to FIG. 2, the received data from the one or more sensors 410 and dimmers 412 may be utilized by the lighting control module 402.

### Power Control Module

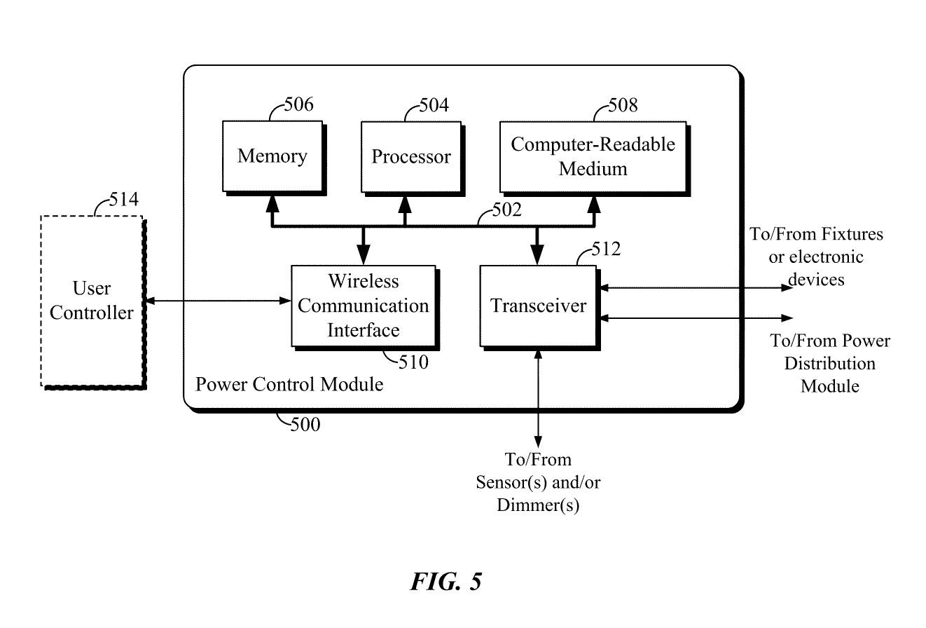

FIG. 5 is a block diagram illustrating a power control module for configuring, programming and controlling multi-channel DC powered devices in multiple zones of power. The power control module 500 may be implemented with a bus-architecture, represented generally by the bus 502. The bus 502 links together various circuits including one or more processors (represented generally by the processor 504), a memory device 506, and computer-readable media (represented generally by the computer-readable medium 508).

The processor 504 (e.g., processor circuit, processing module, etc.) may be coupled to a wireless communication interface 510 to communicate over a wireless network, a communication interface or input/output connections, for example a transceiver 512, to communicate with a power distribution module, as described above, and external devices, such sensors, dimmers, and fixtures, and the memory device 508 to store pre-set applications for controlling fixtures in a lighting control system. The processor 504 may be configured to control multiple channels in multiple DC powered devices, as described above, as well as receive data from one or more sensors and dimmers. The processor 504 may be further configured to generate an environmental report.

A user controller 514 may be utilized by a user to wirelessly configure, program and control the multi-channel fixtures.

The lighting control module may be fitted on a National Electrical Manufacturers Association (NEMA) type enclosure that can be mounted into walls or to structural members within a ceiling or wall cavity.

### Power Distribution Module

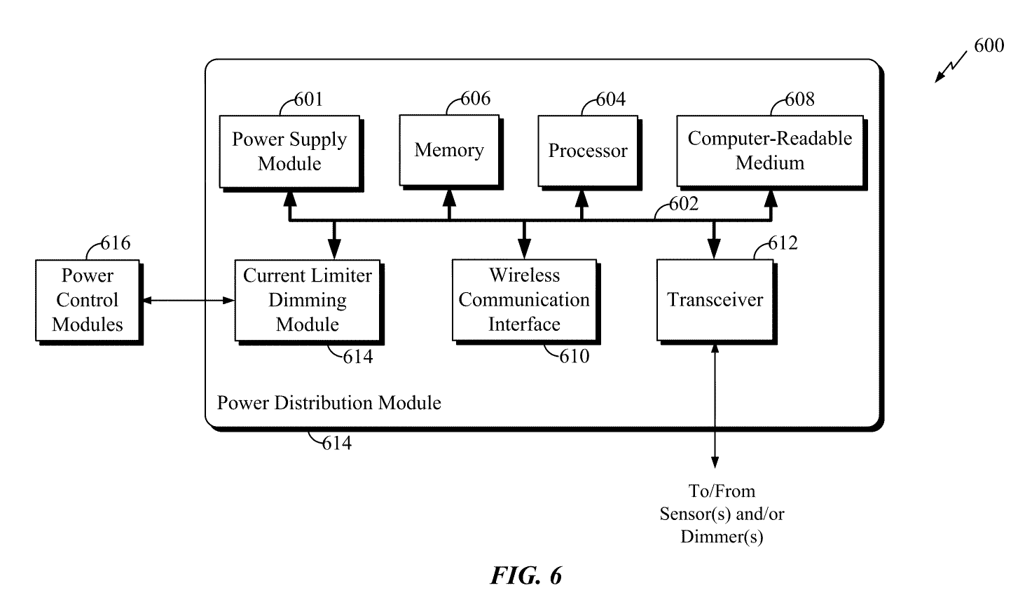

FIG. 6 is a block diagram illustrating a power distribution module for providing power to one or more power control modules for powering multi-channel DC powered devices.

The power distribution module 600 may include a power supply module 601 and may be implemented with a bus-architecture, represented generally by the bus 602. The bus 602 links together various circuits including one or more processors (represented generally by the processor 604), a memory device 606, and computer-readable media (represented generally by the computer-readable medium 608).

The processor 604 (e.g., processor circuit, processing module, etc.) may be coupled to a wireless communication interface 610 to communicate over a wireless network, a communication interface or input/output connections, for example a transceiver 612, to communicate with external devices, such sensors, dimmers, and fixtures, and the memory device 608 to store pre-set applications for controlling DC powered devices in a lighting control system. The processor 504 may be configured to control multiple channels in multiple DC powered devices, as described above, as well as receive data from one or more sensors and dimmers. The processor 604 may be further configured to generate an environmental report.

The power distribution module 600 may also include a current limiter/dimming module 614 for limiting the current supplied to power control modules 616 as well as any internal control modules located within the DC powered devices.

Multi-Channel Light Engine (LED panels)

A light engine is a UL Recognized matrix-style, low power, LED-based module that produces extremely even illumination—optimized for light distribution in relatively shallow cavities—and emits very low heat. Its scalable, configurable modular architecture enables daisy-chaining to other light engines to create a continuous, large surface of illumination. The wide optical angle, high-distribution array approach enables smooth and even illumination conditions with no hot spots, without reflectors or diffusers and without the need of complex lenses which typically trap heat within the LED case and reduce life expectancy.

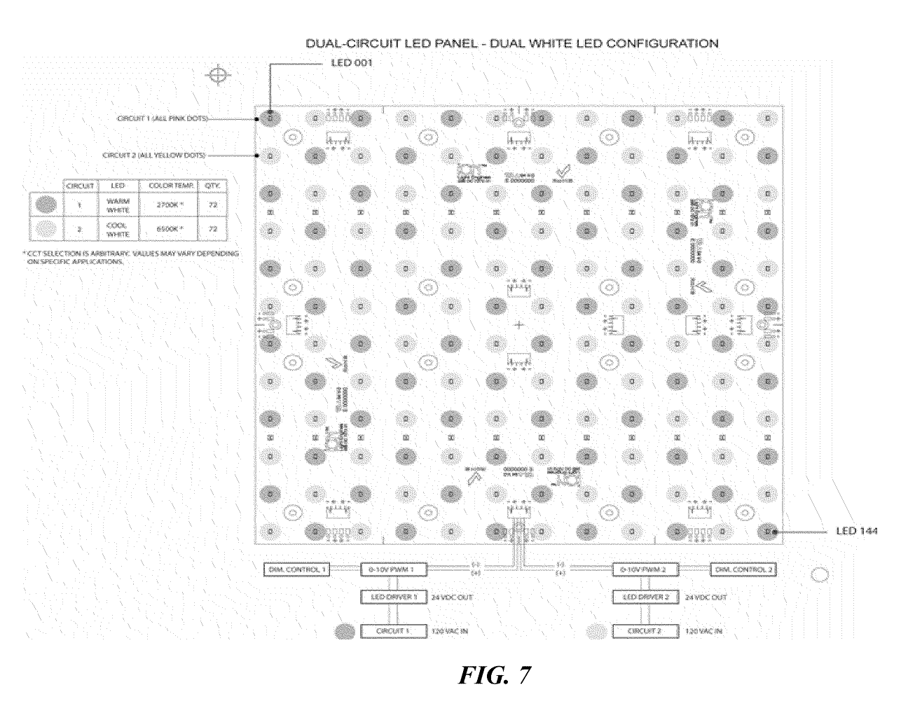

A single printed circuit board assembly may include multiple channels and multiple sets of LEDs. As shown in FIG. 7, a dual-channel light engine having a checkerboard pattern is illustrated where half of the LEDs may be energized when applying current to channel “A” (or a first channel) and the other half of the LEDs may be energized when applying current to channel “B” (or a second channel). Additionally, the Printed circuit board assembly may include multiple inputs (power-in) and through connectors for daisy-chaining to other LED panels of the same type. Each connector may have 4 or more pins, where pins 1-2 may be used to energize channel “A” (or the first channel) and pins 3-4 may be used to energize channel “B” (or the second channel) and so forth. This configuration requires two or more separate power sources or two or more separate channels in order to be effectively controlled. Alternatively, if pins 1-4 are paired and pins 2-3 are paired, the entire LED panel can be energized by a single power source; however all LED's are energized at once.

According to one embodiments, both channels may be populated with the same type and color LED to provide bi-level illumination for use in hallways, stairs, parking structures, etc., where channel “A” remains on at all times, and channel “B” is triggered to turn on when a sensor detects occupancy in that area.

According to another embodiment, channel “A” may be populated with Warm White LED's (i.e. 2,500K) and channel “B may be populated with Cool White LED's (i.e. 10,000K) to provide a White Daylight range that not only suits a variety of needs but also provides an extremely flexible light source for use in commercial office space, schools, retail applications, etc. where the effect of color temperature as it relates to a specific time of the day and its association to the internal human biological (circadian) clock can result into a measurable improvement in workers performance and motivation, reductions in absenteeism, fatigue reduction, increased patient comfort and healing, increased retail sales or stimulation and concentration during a children's learning process.

According to another embodiment, channel “A” may be populated with Blue LED's and channel “B” may be populated with Green LED's to provide a color range that has been determined to be extremely effective for use in the treatment of an assortment of conditions and deficiencies related to sleep disorders and Circadian Rhythm asynchrony, found in persons of all ages.

According to another embodiment, channel “A” may be populated with Warm White LED's (i.e. 3800K) and channel “B may be populated with Cool White LED's (i.e. 4800K) to provide a specific White Light color temperature. In this instance the color temperature of a fixture or a room's light output can be sensed by a color temperature sensor and the processor in the power distribution modules can use software to combine the light output from channel “A and channel “B” to create a predetermined specific color temperature (i.e. 4200K). This can be used to calibrate fixtures or a room's lighting to a certain specific color temperature, without the need to use more expensive LEDs, with a highly accurate color temperature output.

The ability to smoothly dim each channel—individually—enables the user to mix and fine-tune the desired color temperature (within the available color temperature range) in an almost infinite manner, whereas both colors are mixed in the light chamber (the space between the light source and the diffuser lens) and the resulting color output is perceived as one. The color range can also be automated to deliver specific or pre-set color temperatures (i.e. 3,000K, 4,250K, 5,600K, etc.), which proves desirable and effective when working with translucent images (restaurant menu systems, retail displays, etc.) or for use in photographic and filming/broadcasting studios as an illumination source, or when providing illumination during telepresence and teleconferencing sessions.

The light engine may also include a compartmentalized design which enables the light engine to be used as a whole or to be cut into multiple sub-sections without having an effect on its core properties, while always providing input-output (daisy-chaining) connectivity, yet retain its dual-channel capabilities and flicker-free dimming functions.

This feature enables the design of light fixtures or illuminators of varied sizes and shapes, whereas all of the modules within the fixture are spun-off a single LED panel.

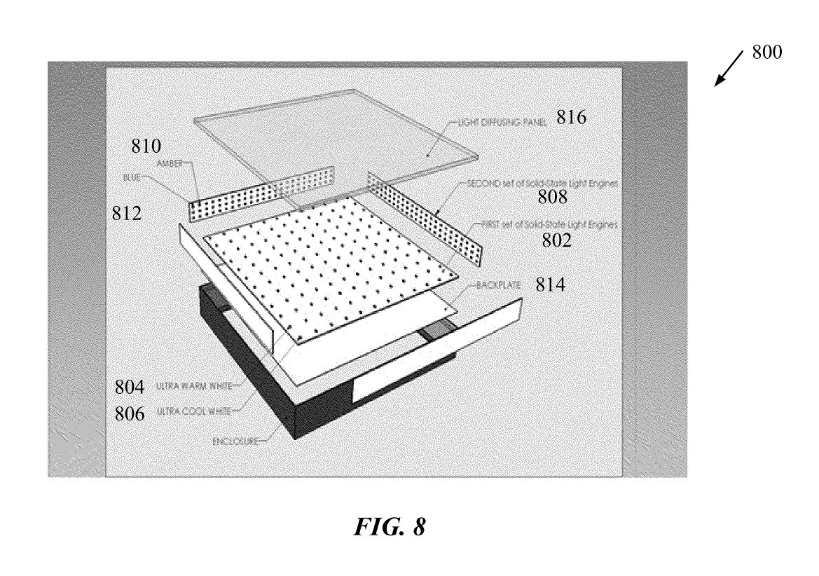

FIG. 8 illustrates an exploded view of a four color illuminating device according to one example. The four color illuminating device 800 may include a first set of dual-circuit light engines (or LED panels) 802 where the first circuit 804 encompasses 2,500 Kelvin white LED chips (ultra-warm white) and the second circuit 806 encompasses 8,000 Kelvin white LED chips (ultra-cool white) and a second set of dual-circuit light engines (or LED panels) 808 where the first circuit 810 encompasses 600 nanometer (Amber) LED chips and the second circuit 812 encompasses 470 nanometer (Blue) chips (cool white).

The first set of light engines (2,500K/8,000K) 802 may be mounted on the back plate 814 of the device 800 (parallel to the light diffusing panel 816), while the second set of light engines (600 nm/470 nm) 808 may mounted on the internal periphery of the device, perpendicular to the light diffusing panel 816. Every individual circuit (4 in total) may individually wired and controlled by a single power control module.

The first set of light engines (2,500K/8,000K) 802 may be used in healthcare applications, commercial office spaces, schools, retail and other applications where it is desirable to have variable white color temperature, as it has been demonstrated to render increased patient comfort and healing, a measurable improvement in workers performance and motivation, reductions in absenteeism, fatigue reduction, increased retail sales or stimulation and concentration during a children's learning process.

The second set of light engines (600 nm/470 nm) 808 may be used in senior living facilities in such a manner that minimizes disruption of patient's sleep by nursing staff entering the room for check-ups, since its intensity and color wavelength does not kick-start hormone secretion (600 nm Amber). Accordingly, it provides visual guidance to elderly patients during night hours without incurring into sleep pattern disruptions typically caused by white lights.

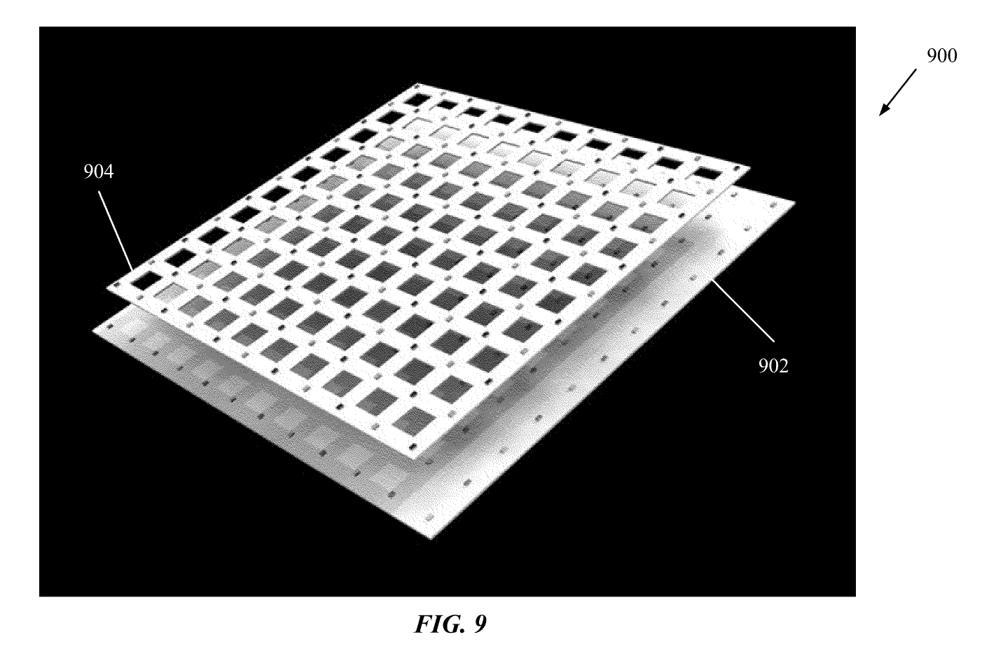

FIG. 9 illustrates an exploded view of a four color illuminating device according to one example. The four color illuminating device 900 may include a first set of dual-circuit light engines (or LED panels) 902 where the first circuit encompasses 2,500 Kelvin white LED chips (ultra-warm white) and the second circuit encompasses 8,000 Kelvin white LED chips (ultra-cool white) and a second set of dual-circuit light engines (or LED panels) 904 where the first circuit encompasses 600 nanometer (Amber) LED chips and the second circuit encompasses 470 nanometer (Blue) chips (cool white). According to one embodiment, the second set of dual-circuit light engines (or LED panels) 904 may have a “grid-like” configuration, i.e. an array that has an orthogonal (horizontal/vertical) set of electrical traces, resistors and LEDs chips with the minimum amount of material in the spaces between the aforementioned traces and electrical components—enabling a multitude of empty spaces with no material, enabling the grid-like panel to be mounted over the first set of LED panels 902 (mounted to the device's back plate) without producing internal shadows or obscuration.

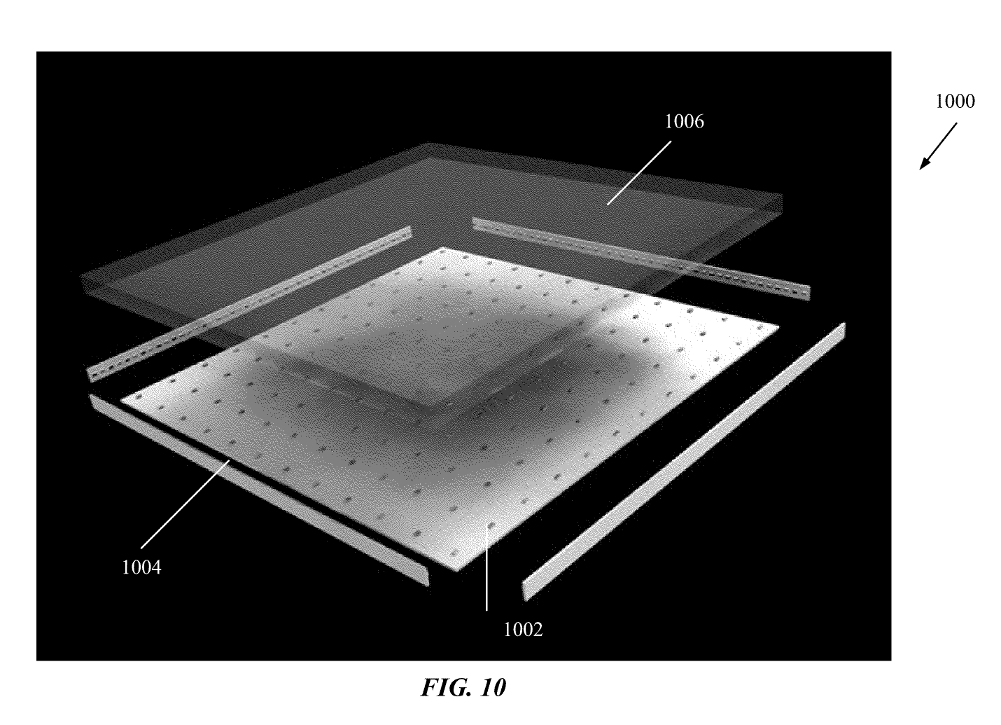

FIG. 10 illustrates an exploded view of a four color illuminating device according to one example. The four color illuminating device 1000 may include a first set of dual-circuit light engines (or LED panels) 1002 where the first circuit encompasses 2,500 Kelvin white LED chips (ultra-warm white) and the second circuit encompasses 8,000 Kelvin white LED chips (ultra-cool white) and a second set of dual-circuit light engines (or LED panels) 1004 where the first circuit encompasses 600 nanometer (Amber) LED chips and the second circuit encompasses 470 nanometer (Blue) chips (cool white). According to one embodiment, the second set of dual-circuit light engines (or LED panels) 1004 may be placed perpendicular to the front plane and in direct proximity to an edge-lit clear lens 1006 which is casted and may include a highly reflective batch compound (such as titanium oxide) that is mixed during the casting process and while it is practically imperceptibly by the naked eye (other than creating a slight “foggy” appearance) it is evenly spread within the body of the edge-lit lens. Thus, the first set of light engines 1002 (warm/cool white) emanates light “through” the edge-lit lens 1006 and the second set of light engines 1004 emits light at the entire perimeter of the edge-lit lens 1006, whereas the emitted light travels within the lens (perpendicular to the frontal plane) and as it travels it becomes redirected towards the front plane of the lens when the light impacts against the embedded particles suspended within the edge-lit lens 1006.

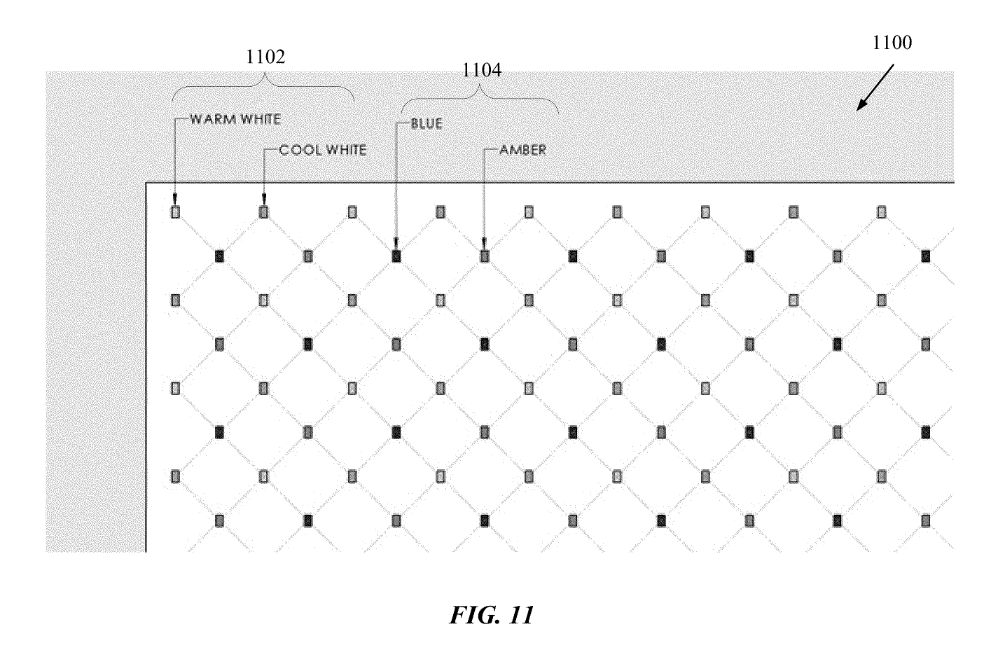

FIG. 11 illustrates a partial view of a pattern for a LED panel according to one example. The four color LED panel 1100 may include a first set of dual-circuit light engines (or LED panels) 1102 where the first circuit encompasses 2,500 Kelvin white LED chips (ultra-warm white) and the second circuit encompasses 8,000 Kelvin white LED chips (ultra-cool white) and a second set of dual-circuit light engines (or LED panels) 1104 where the first circuit encompasses 600 nanometer (Amber) LED chips and the second circuit encompasses 470 nanometer (Blue) chips (cool white). The first set and second set of dual-circuit light engines 1102, 1104 may be combined into a single light engine comprising four independent channels.

### Audio Enabled Illuminating Device

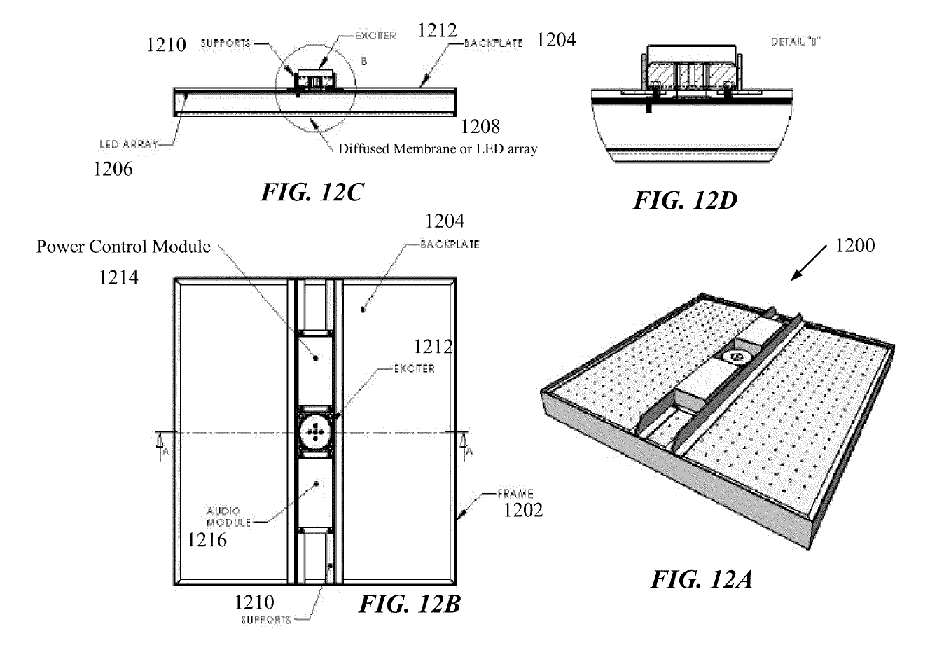

FIG. 12A illustrates an audio enabled illuminating device according to one example. FIG. 12B illustrates a top plan view of the audio enabled illuminating device of FIG. 12A. FIG. 12C illustrates a cross-sectional view taken along line A-A of FIG. 12B. FIG. 12D illustrates an enlarged view of Detail B of FIG. 12C. The following discussion relates interchangeably to FIGS. 12A-12D.

According to one embodiment, the audio enabled illuminated device 1200 may serve a dual-function by not only illuminating a space but reproducing sound. In one example, the audio enabled illuminated device 1200 may be designed for use in a suspended ceiling grid system. The illuminating device 1200 may comprise an aluminum frame 1202 surrounding the fixture, a thin aluminum back plate 1204, bonded to the frame 1202 in its entire periphery, a flexible printed circuit board or LED array 1206 bonded to the back plate 1204, and a diffusing membrane (or LED array) 1208 stretched along the front surface of the device. The diffusing membrane 1208 provides extremely even illumination throughout the surface and is virtually acoustically transparent.

In some embodiments, support channels 1210 may be located on the rear of the device, where an audio exciter 1212 (i.e. driver, motor or transducer) may be mechanically attached. A housing for a power control module 1214, described above, and an audio module 1216 may be attached to the same support members.

The exciter 1212 may have a moving coil configuration (a wounded copper wire coil residing inside a magnetic gap) and a coupling device that links the voice coil body to the surface to be excited (the aluminum back plate 1204). The coupling device may be permanently bonded to the rear of the back plate 1204 with a high-durometer epoxy compound which transmits high frequencies with minimal losses. As the exciter 1212 energizes the back plate 1204, a flexible printed circuit board (or LED array) may vibrate along, since it is fully bonded to the internal side of such back plate. Both, in unison, may produce sound in a wide frequency range. The radiated sound may penetrate through the diffusing membrane and disperse throughout the space, as sound radiated from a planar surface using the aforementioned principles has extremely wide dispersion characteristics, sometimes 140 degrees or higher at full bandwidth.

While the power control module 1214 controls operation of the lighting fixture portion, the audio module 1216 may provide power to the exciter 1212 and permit remote access to a sound library, power output control, etc.

In one embodiment, the light output levels and color temperature settings of the device can be conditioned (programmed) to match a specific type of sound with the natural lighting conditions where the sound is typically heard. For example, the sound of chirping birds may have different lighting conditions than the sound of crickets.

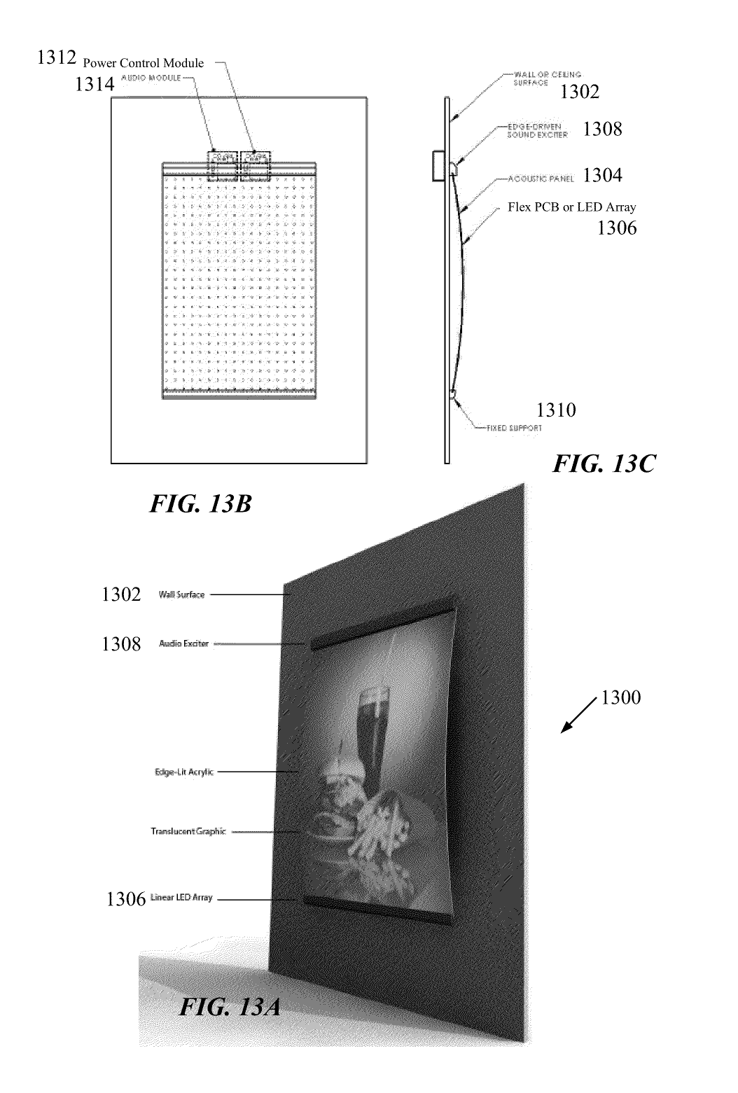

FIG. 13A illustrates an audio enabled illuminating device according to one example. FIG. 13B illustrates a side plan view of the audio enabled illuminating device of FIG. 13A. FIG. 13C illustrates a side view of the audio enabled illuminating device of FIG. 13A. The following discussion relates interchangeably to FIGS. 13A-13C.

According to one embodiment, the audio enabled illuminating device 1300 may be affixed to a wall 1302 and excite a relatively flat and thin membrane or panel 1304 by driving (energizing) the material from the edge—instead than from the rear surface of the panel. The edge-driving principle makes the panel flex (or curve) when the panel is rigidly affixed, therefore displacing air and creating sound.

The acoustic panel 1304 may be comprised of a suitable material to reproduce sound, such as foamed material or solid ABS plastic, which can flex without damage—to a certain extent. The material may be pre-shaped, so it is intentionally curved to a specific shape (by heating, molding, etc.) A flexible printed circuit board or LED array 1306 may be laminated at the front of the acoustic panel 1304 in its entirety or the LED array itself may be the acoustic panel.

In one or more embodiments, a sound exciter 1308 may be attached to one edge of the acoustic panel or LED array or LED panel 1304. The opposite end of the acoustic panel 1304 may be rigidly supported 1310 to enable the panel 1304 to flex as the sound exciter 1308 applies a force to its edge. Such effect forces the panel to “breathe” (compress & extend at various frequency rates, according to the signal applied to the exciter) and produce sound. The sound exciter 1308 may have the capacity (power and displacement) to transfer enough force at the edge of the flexible printed circuit board or LED array 1306 and acoustic panel 1304 so it flexes as intended.

According to one embodiment, the audio exciter 1308 (driver, motor or transducer) can be a moving coil configuration or other configuration. The power control module 1312 and the audio module 1314 may located be remotely and provides access to the sound library, power output control, etc. The may be remotely located.

According to one embodiment, the audio enabled illuminating device 1300 may be utilized by quick-serve restaurants (QSR) as a menu board. The QSR operator can set the color temperature and level of each menu board opening (image) based on, for example, corporate recommendations and in accordance to the food items on display. Furthermore, the QSR operator can set the menu board intensity level to compensate for incident light (natural or artificial) as it changes during the day, adjust the level of the drive-thru display according to the time of the day, either to increase visual impact or reduce energy.

According to one embodiment, one or more the audio enabled illuminating devices may be used to wirelessly stream sound from the individual carrying the mobile device that is in communication with the system. As the individual changes location within the residence, the streamed sound follows the individual (the device at the original location disengages and the device at the current location engages), instead of having the entire home streaming music at once.

### Audio Module

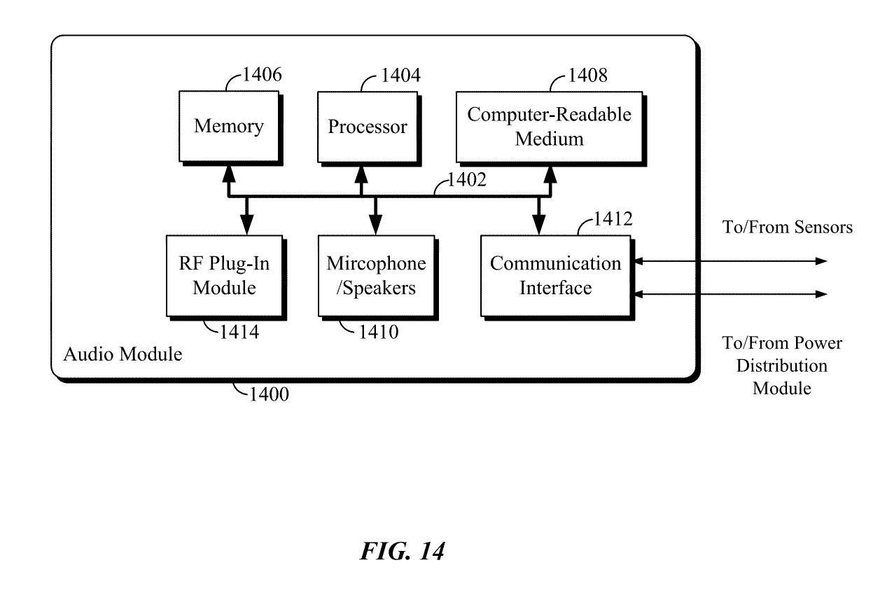

FIG. 14 illustrates an audio module according to one example. The audio module 1000 may enable the handling of input data, such as volume changes, ON/OFF states, sound library access and program selection, as well as time-based functions when a user determines that a specific sound shall start and end at certain time intervals.

The audio module 1400 may be implemented with a bus-architecture, represented generally by the bus 1402. The bus 1402 links together various circuits including one or more processors (represented generally by the processor 1404), a memory device 1406, and computer-readable media (represented generally by the computer-readable medium 1408).

The processor 1404 (e.g., processor circuit, processing module, etc.) may be coupled to a microphone and speakers 1410 for receiving and transmitting audio signals and a communication interface 1412, to communicate with a power distribution module, as described above, and external devices, such as sensors, dimmers, and fixtures, and the memory device 1408 to store one or more sound libraries. According to one embodiment, voice activated sensors may be used to trigger events such as ON/OFF and dim. The voice activated sensors may include a microphone for capturing audio which may be sent to a processor, in the power control module, which may be embedded with voice recognition algorithms.

According to one embodiment, instead of inserting a media card into the audio module 1400 to access sounds within the card via remote application software, the audio module 1400 may include a “RF Plug-In Module” 1414, such as WiFi® or Bluetooth®. By having the audio module at the device, sound files (MP3, AAC, AIFF, WAV) can be directly streamed from the sound library contained in a wireless-enabled media player such as an iPhone® or iPod Touch®, where the user selects the file(s) to be played and establishes the output level.

In addition to pre-recorded sounds, the sound library may also include a high-quality, extended length sound masking noise. Sound masking provides a constant, fixed level of unobtrusive background sound that is set to cover speech level and soften other office noises, which then do not appear as distractions to the human ear. Because sound masking is complementary to the speech spectrum and effectively covers speech levels, it reduces the intelligibility of conversations, which makes conversations less distracting to those working nearby.

### Control Panel

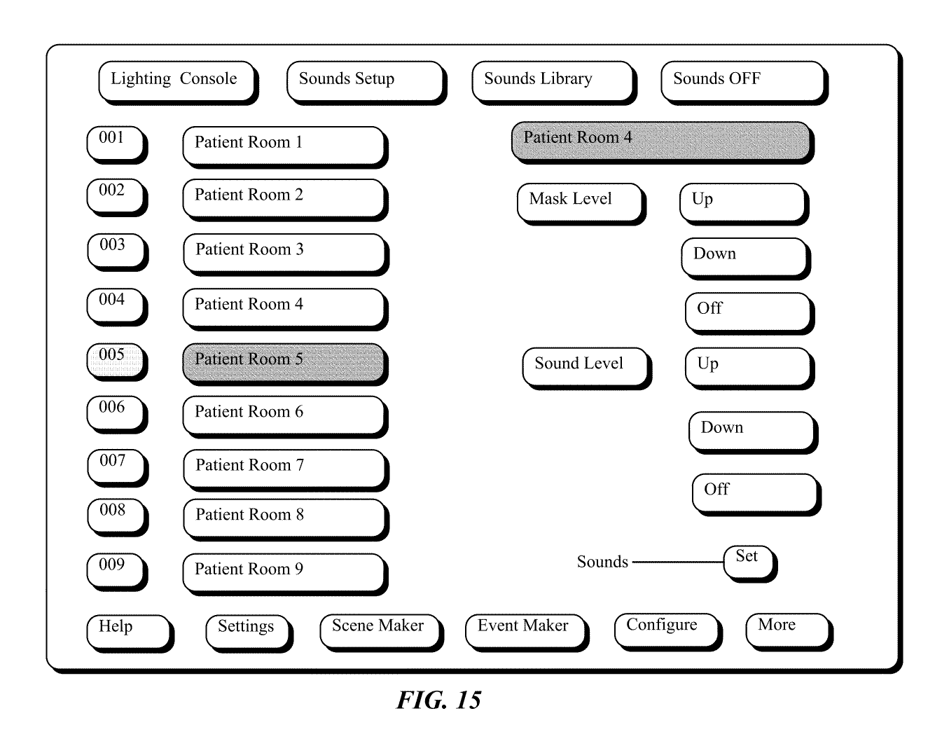

FIG. 15 illustrates a screen shot of a program for providing wireless access to the configuration, management and control features of a centralized power and control system for DC powered devices.

An installer may utilize the program to access and configure a multi-zone lighting system, establish wireless RF communication between devices, assign color schemes, channels and power configurations to each independent zone, commission dimmers and sensors.

A manager (i.e. Facilities/IT Manager/System Manager Owner) may utilize the program to institute password-protected system settings, name each individual zone, commission multiple mobile devices (i.e. employee phones) for specific zone control, assign or limit certain special functions to each user (based on a hierarchical or need-to-use approach), assign scheduling features, or de-commission devices and functions as required, at any time and without disrupting daily activities. Having a hierarchical administration of the system's features permits operation of such without going beyond a set of pre-defined boundaries. According to one example, a retail manager can operate the system on a daily basis while the owner may set the store's On-Off schedules. According to another example, a homeowner can create and name an event where every zone in the entire residence is pre-set to a color and intensity scheme specifically tailored to create a certain mood (i.e. Dinner Party), while others can only access the specific button that triggers that event but cannot change it.

A user may utilize the program to have personal control of his/her workspace, such as On/Off, dimming, color temperature tuning and scheduling, as well as special and advanced functions further explained in detail on this document. The user may also control other zones in a building depending on the user needs or based on needs, corporate authorization, etc.

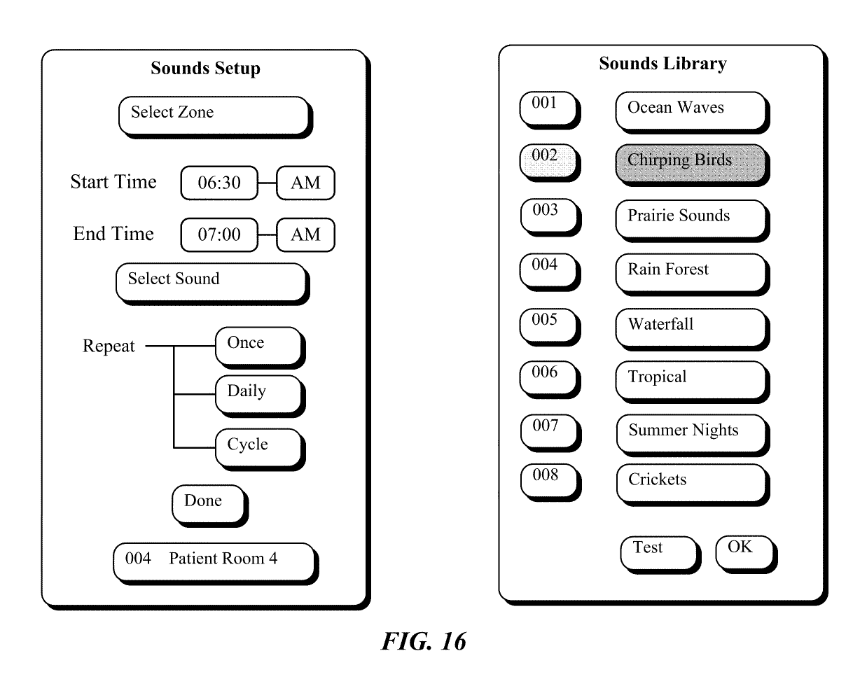

As shown in FIG. 15, a centralized power and control system may be utilized in a hospital. The installer, manager and/or user may select a patient's room and adjust the lighting and/or sound in the selected room. To adjust the sound, a sounds setup button may be selected causing a sounds setup screen to appear (See FIG. 16A). The sounds setup screen allows the installer, manager and/or user to select the zone in which to configure and control. Once a zone is selected, a start and end time may be entered, as well as how often the sound is to be played, and the sound to be emitted may be chosen by selecting a select sound button causing a sounds library screen to appear (See FIG. 16B). The sounds library screen identifies the available sounds to choose from and gives the installer, manager and/or user the opportunity to first test the sound prior to making a final decision.

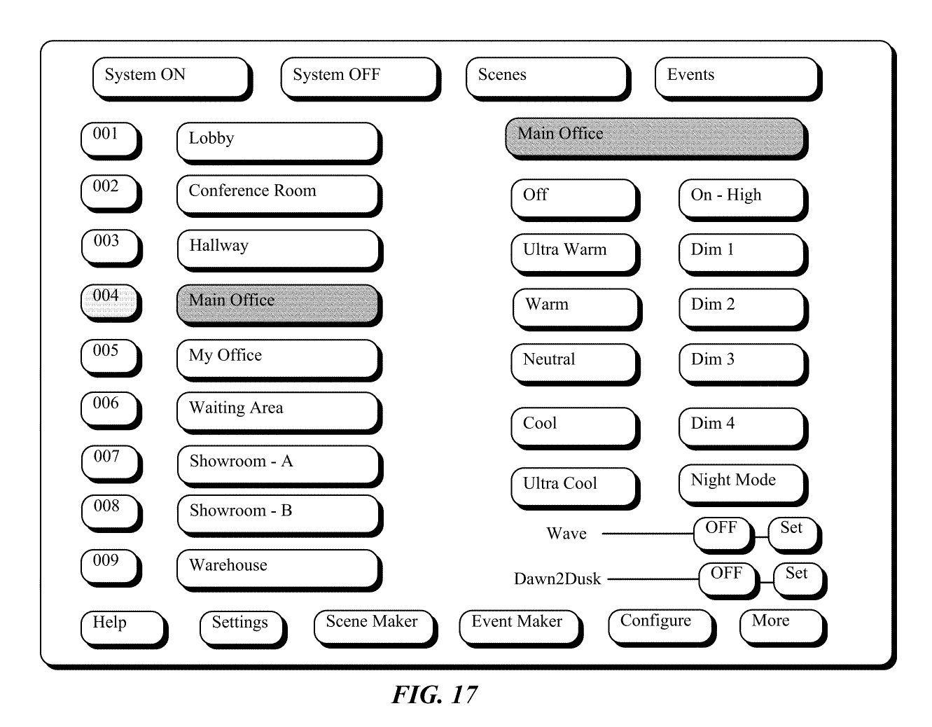

FIG. 17 illustrates a screen shot of a program for providing wireless access to the configuration, management and control features of a centralized power and control system for DC powered devices, according to one example. As shown in FIG. 17, a centralized power and control system may be utilized in an office building.

By selecting a “wave” button, an installer, manager and/or user can select a color A/B range (within the available colors), select the starting and ending time, and the repetition (once—daily—cycle). Once set, the selected color range may smoothly intermix based on a pre-set algorithm that can be time-modified (stretched or shortened based on duration).

By selecting a “Dawn2Dusk” button, an installer, manager and/or user can select the starting and ending time, and the repetition (once—daily—cycle) of the function. Once set, Dawn2Dusk simulates the color-correlated temperature range of sunlight from early morning to late afternoon over the time range selected by the user. The Dawn2Dusk function can be set to slow-down or accelerate the natural dawn-to-dusk effect for the purpose of stimulating a health condition (i.e. simulating a morning to afternoon color transition in 6 hours (in a room where there are no external visual cues that would enable the user/patient to decipher actual time).

“Scene Maker” and “Event Maker” buttons may be selected to create pre-programmed varying of light level, light color, and sound based on start/stop times from the clock-calendar or for pre-determined periods of time.

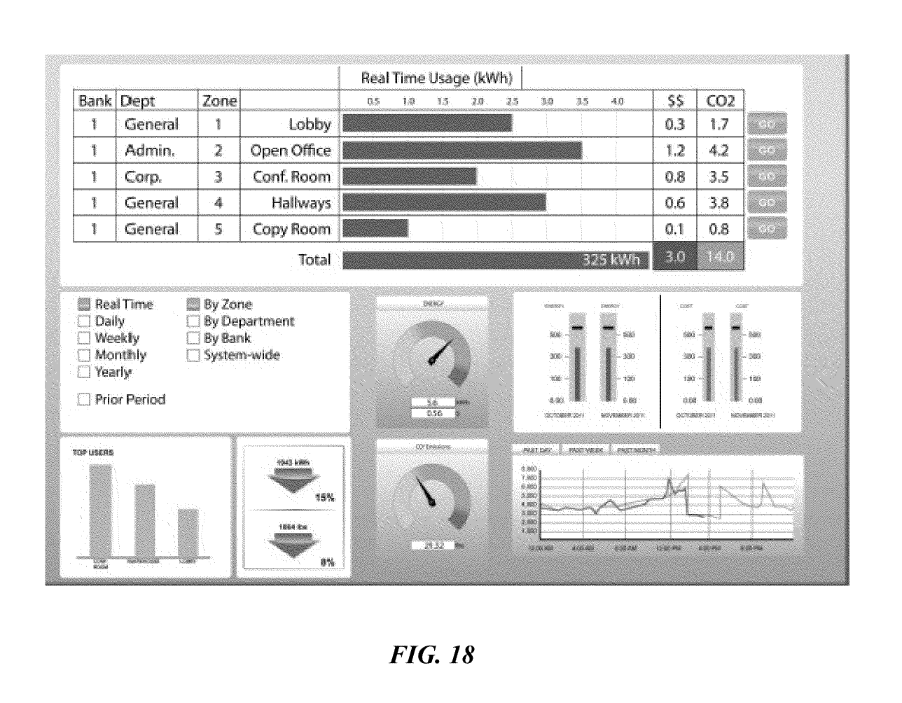

FIG. 18 illustrates an example of an energy monitoring panel according to one example. The processor, in combination with the current limiter of the power control module described above, may provide feedback from the DC power devices which are being controlled by the system. When such information is processed and organized properly it can be utilized to provide real-time energy use in the system. Furthermore, data can be stored and then processed to make comparative analysis and make energy-saving decisions. When the data is graphically displayed on a metering panel or dashboard it provides a simple way for the system administrator to facilitate maintenance schedules, evaluate energy usage, establish energy-saving targets, calculate and estimate energy costs, compare usage to prior periods, analyze usage per department, view occupancy data, view seasonal energy use or merely be displayed for informational and educational purposes.

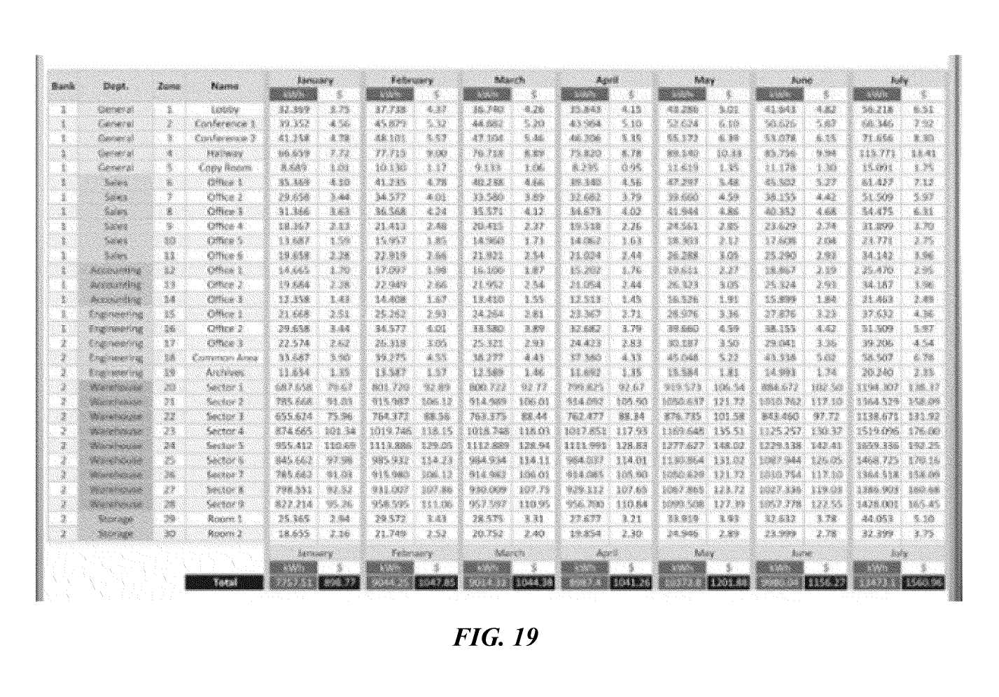

FIG. 19 illustrates an example of an energy monitoring panel according to one example. In this example, the feedback from the DC power devices is provided in an electronic spreadsheet identifying energy usage and costs.

### Additional Markets

In addition to controlling light fixtures, the control modules can be used in various other markets, fields and industries, such as quick-serve, retail, educational and healthcare markets. For example, (1) a proximity or distance sensor can detect a person or object and trigger a change in light intensity, or a Go-No go event (green/red light); (2) a thermocouple can detect an over-temperature or Δt (temp. differential) condition and trigger a “visual” warning (light strobe effect, or amber=hot/blue=cold); (3) a smoke or CO₂ sensor can trigger a strobe effect; (4) a fog sensor can trigger a color temperature change that provides improved visibility conditions (i.e. vessel/car/bike/bicycle headlights) or on outdoor building structures (i.e. parking lot); (5) an inductive loop, pressure or capacitance sensor mounted on a drive-thru can trigger a menu-board to increase light intensity from 50% to fully ON and back to 50% when the event terminates (vehicle leaves premise); and (6) to power or recharge office products such as laptop computers, printers, phones, hand-held computers, etc. All of these iterations can be controlled in a predetermined and controllable manner as programmed in the power distribution module.

### Methods of Manufacturing

According to one embodiment, ultra-thin, lightweight illuminators (or illuminating devices) may be manufactured. Ultra-thin lightweight illuminating devices allow for the reduction of components and assembly labor, resulting in a significant reduction of overall product and shipping costs. Thus, a carbon footprint reduction during manufacturing and shipping, as more products can be stored and shipped in the equivalent volume of a typical light fixture or illuminating device, may be achieved.

The illuminating device may be a ready to install fixture the can be, for example, dropped in a suspended ceiling grid, flush mounted on a wall or ceiling, suspended by cables (pendant) or similar method. The overall thickness may be approximately a ¼ inch or less, depending on the final configuration, and does not need an enclosure or surrounding frame.

The mechanical strength of the illuminating device may be accomplished by laminating two or more layers of components. In one embodiment, the illuminating device may include a frontal lens (first component), a bonding agent (second component), and a light engine (third component) where the LED's may be organized in an orthogonal pattern on a printed circuit board or panel that provides and distributes the required current/power for the LED's to operate as intended. Optionally, a rear barrier or back-cover or back plate (fourth component)—may be utilized depending on the electromechanical configuration of the second component.

The first component, a frontal lens, may be manufactured using thermoplastic polymers, such as Clear Polycarbonate (PC), more commonly known as Lexan®, Makrolon®, etc. and Polymethyl Methacrylate (PPMA)—commonly known as acrylic glass, branded under names such as Plexiglas®, Altuglas®, Lucite®, Perspex®, Optix® and other by different manufacturers.

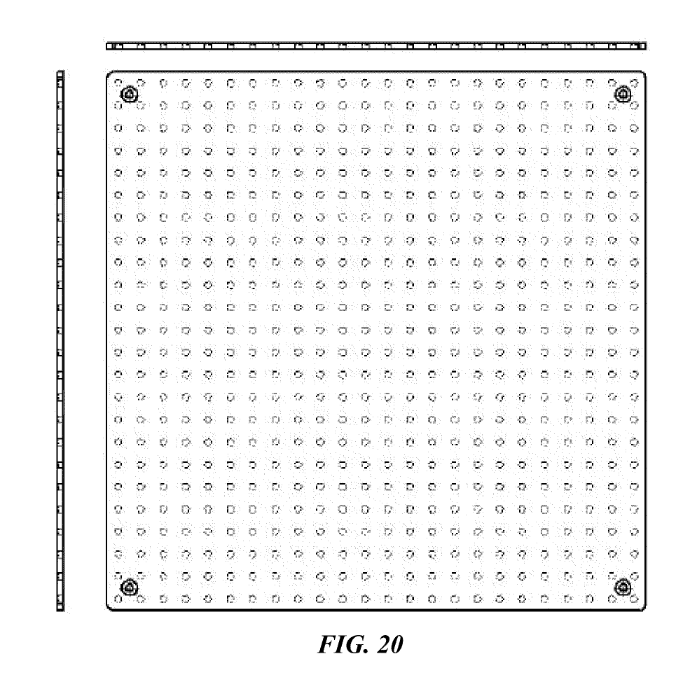

Injection molding may be used to manufacture the frontal lens. The mold may produce a frontal lens having an array of recessed holes and interconnecting lines of a certain depth between holes, forming a decorative pattern. The recessed holes in the pattern may be used to house the body of the LEDs once the printed circuit board is laminated into the lens. (See FIG. 20)

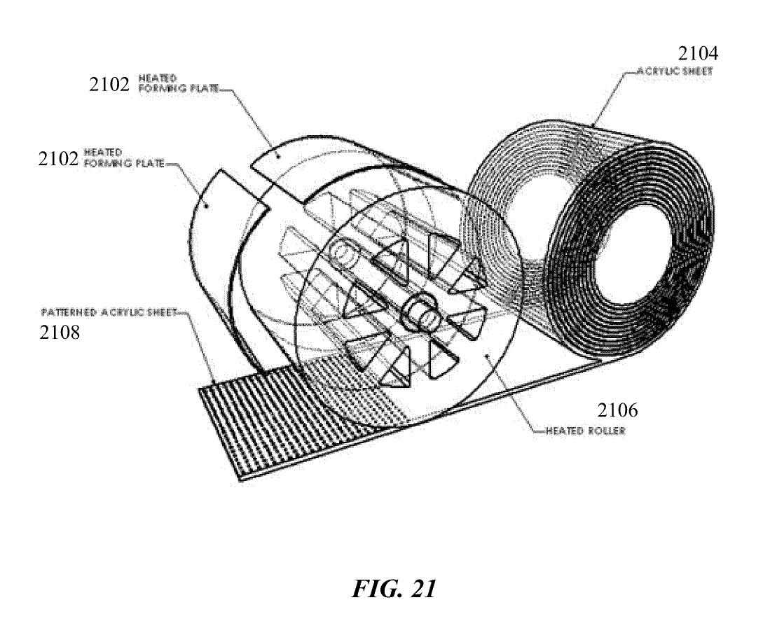

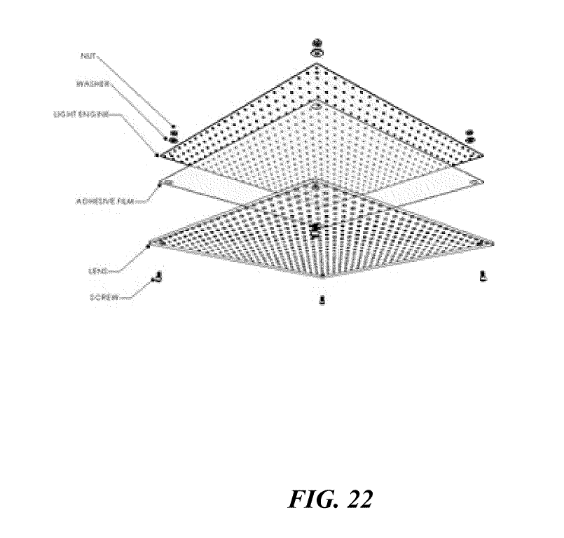

According to one embodiment, the frontal lens may be manufactured by pressure-applying a heated plate 2102 with a continuous pattern into the surface of an extruded acrylic sheet. As the extruded sheet of acrylic 2104 is guided through the heated roller 2106, the pattern on the surface of the roller creates the indentations over the acrylic surface 2108. A secondary operation cuts the acrylic sheet 2108 to the desired dimensions. The aforementioned sheet can also be supplied in roll forms of several hundred feet. Since the lens patterns can be more than one, the plate affixed to the heater roller can be exchanged as required. (FIG. 21)

According to one embodiment, the frontal lens may be manufactured by routing the pattern over the acrylic or polycarbonate sheet. Although this method may be more labor/time intensive, it provides extremely flexible configurations without the cost of fabricating a steel mold.

The frontal lens may also be manufactured by chemical etching or sandblasting.

The second component, a bonding agent or adhesive, may be applied over the rear surface of the lens. Such adhesive can be the heat activated (thermo-set), immediate contact, anaerobic, epoxy-based, UV curable or other types, either in liquid, spray or film form.

The third component is the light engine. According to one embodiment, the light engine may be a two-layer FR-4 (Fiberglass+Phenolic resin composite) printed circuit board, anywhere between 0.8 mm and 1.5 mm thick. The overall length/width dimensions may depend on the product requirements, the equipment available to populate the panel (pick-n-place machine), and wave soldering machines. Preferably, the light engine or printed circuit board (PCB) may be approximately 24″×24″ or 12″×24″. Internally, the PCB may have one-ounce etched copper sheets to conduct current to the LED strings. Externally, the LED's may be mounted over the front surface and are forward-firing (TOPLED). A series of Resistors are also mounted on the same surface, each controlling the current available to a series of LED's on a string. Provisions for connection to an external Class-2 DC power source may be located on the front and rear surfaces of the PCB (solder pads), where a ribbon or flat wire can be attached. The rear surface of the PCB may be flat with are no components or connectors. All external surfaces may be white-masked

According to one embodiment, the light engine may be a two-layer flexible printed circuit board or PFC having electronic components mounted to a thin, flexible polyimide, silicone, PEEK or transparent conductive polyester—where the silver circuits are screen-printed over the polyester surface. (Photolithographic technology). A flex-PCB can also be manufactured by laminating thin copper strips between 2 layers of plastic with thermo-set adhesives. The overall length/width dimensions of the flex-PCB may depend on the product requirements, the equipment available to populate the panel (pick-n-place machine), and wave soldering machines. Preferably, the flex-PCB may be approximately 24″×24″ or 12″×24″. The LED's may be mounted over the front surface and are forward-firing (TOPLED). A series of Resistors may also be mounted on the same surface, each controlling the current available to a series of LED's on a string. Provisions for connection to an external Class-2 DC power source may be located on the front and rear surfaces of the flex-PCB (solder pads), where a ribbon or flat wire can be attached. The type of connector can be a ZIF (zero insertion force) termination on the flex-PCB, mating to a rigid connector outside of the device.

According to one embodiment, the light engine or PCB may be a high-temperature, UL 94V-0 rated Plastic or Phenolic sheet, anywhere between 0.5 and 1.5 mm, with a specific length and width, which is initially placed on an inkjet printer. The material may be originally white. Preferably, the PCB may be approximately 24″×24″ or 12″×24″. The inkjet printer may be loaded with a thermally conductive, silver filled ink. The circuit tracing may be printed on the top surface of the plastic sheet. Solder pasting and electronic component placement may be accomplished using standard silk-screening and automated pick-n-place techniques. The LED's may be mounted over the front surface and are forward-firing (TOPLED). Provisions for connection to an external Class-2 power source may be located on the front and rear surfaces of the PCB, where a ribbon or flat wire can be attached.

As described above, the optional fourth component may be a rear bather. The rear barrier may depend on the type of PCB to be used, the thermal dissipation requirements and the Electrical/Safety/Building Code compliance requirements. If or when a barrier is required, such is preferably a thin aluminum sheet (approximately 0.030″ thick) acting as a heat dissipater (heat-sink).

An illumination device, as described above, may require anchoring points or earthquake clips in compliance to Building Codes. In order to mechanically attach such clips on the rear of the device—and when the device does not have a rear barrier—it may be necessary to “sandwich” the frontal lens and light engine with a bolt and nut. For pendant-mounting applications, when the device has no rear barrier, a similar “sandwich”+bolt and nut approach may be used. In both above cases, the frontal lens may have through-holes near to all corners, which match and align with through-holes on the corners of the light engine. Decorative bolt or screws may be inserted through the front of the lens—passing through lens and light engine—while the required hardware is attached on the rear side of the fixture and then affixed with a serrated washer/nut combination. Additionally, the illumination device may require mounting holes for use when it is to be flush-mounted to a wall or ceiling surface. Using the same through-holes on the lens as described above, the device can be fastened to the surface with drywall anchoring hardware and bolts/screws.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One or more of the components and functions illustrated in the figures may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A multi-channel power control system, comprising:
a power distribution module, comprising:
a power supply module for converting alternating current into direct current; and
a current limiter-dimming module for receiving and restricting the direct current output of the power supply module;
one or more fixtures having at least a first set of LEDs energized through a first channel and a second set of LEDs energized through a second channel; and
one or more power control modules powered by the power distribution module, each power control module in the one or more power control modules comprising:
a memory device; and
a processor, coupled to the memory device, configured to individually control the first and second channels of the one or more fixtures.

2. The system of claim 1, wherein the processor in the each power control module is connected to a multi-channel dimmer, the multi-channel dimmer configured for individually dimming each channel in the one or more fixtures.

3. The system of claim 2, wherein the multi-channel dimmer includes a plurality of dimming control modules for controlling each channel in the one or more fixtures.

4. The system of claim 1, wherein the processor in the each power control module is further configured to receive data from one or more sensors connected to the one or more power control modules or directly from the power control module, the sensor data used to adjust the one or more fixtures and generate an environmental report for energy usage.

5. The system of claim 4, wherein the one or more sensors includes at least one of an occupancy sensor, a daylight sensor, a biometric feedback sensor, a security sensor, and an environmental sensor, wherein the environmental sensor includes at least of a temperature sensor, an O₂ sensor, a CO₂ sensor, a sound level sensor, an audio input sensor.

6. The system of claim 1, wherein the one or more power control modules further includes a third set of LEDs energized through a third channel and a fourth set of LEDs energized through a fourth channel; and
wherein the first set of LEDs radiates light at a first color temperature, the second set of LEDs radiate light at a second color temperature, the third set of LEDs radiate light at a third color temperature and the fourth set of LEDs radiate light at a fourth color temperature, where the first color temperature, the second color temperature the third color temperature and the fourth color temperature are different colors.

7. The system of claim 1, further comprising:
a wireless control module communicatively coupled to the one or more power control modules and/or the power distribution module; and
a user controller, wirelessly connected to the wireless control module, configured to:
adjust settings on the one or more fixtures;
program applications for controlling the power control system; and
receive data from one or more sensors connected to the one or more power control modules.

8. The system of claim 7, where the user controller is further configured to generate environmental reports for monitoring energy usage.

9. The system of claim 1, wherein the memory device stores pre-set applications for controlling the one or more fixtures.

10. The system of claim 1, wherein the one or more power control module dims and mixes colors of each channel of LEDs in the one or more fixtures.

11. The system of claim 1, wherein the power supply module is a class 1 or a class 2 power supply.

12. The system of claim 1, wherein each of the one or more fixtures, comprises:
an exciter communicatively coupled to the at least first and second channels for energizing the at least first and second set of LEDs;
an audio module for providing power to the exciter and permitting remote access to a sound library located in the memory device of the one or more power control modules.

13. The system of claim 12, wherein the one or more fixtures further comprises:
a back plate; and
a LED array, affixed to the back plate, comprising the at least first and second set of LEDs;
wherein the exciter energizes the back plate causing the back plate and the LED array to vibrate in unison producing sound; and
wherein the LED array is a single flexible printed circuit board.

14. A multi-channel power control system, comprising:
a power supply module for converting alternating current into direct current;
a current limiter module for receiving and restricting the direct current output of the power supply module;
one or more fixtures connected to the current limiter module, the fixture having at least a first set of LEDs energized through at least a first channel and a second set of LEDs energized through a second channel;
a power control module, the current limiter module connected between the power supply module and the power control module, the power control module comprising:
a memory device; and
a processor, coupled to the memory device, configured to individually control the first and second channels of the one or more fixtures;
a multi-channel dimmer module, in communication with the processor, having a plurality of dimming control modules for individually controlling each channel in fixture; and
one or more sensors, in communication with the processor, configured for adjusting the fixture.

15. The system of claim 14, further comprising:
a wireless module communicatively coupled to the control module; and
a user controller, wirelessly connected to the wireless control module, configured to:
adjust settings on the one or more fixtures;
program applications for controlling the one or more fixtures; and
receive data from one or more sensors connected to the one or more power control modules.

16. The system of claim 15, wherein the multi-channel dimmer and the sensor are wirelessly connected to the wireless module.

17. The system of claim 14, wherein the power control module further includes a third set of LEDs energized through a third channel and a fourth set of LEDs energized through a fourth channel; and
wherein the first set of LEDs radiates light at a first color temperature, the second set of LEDs radiate light at a second color temperature, the third set of LEDs radiate light at a third color temperature and the fourth set of LEDs radiate light at a fourth color temperature, where the first color temperature, the second color temperature the third color temperature and the fourth color temperature are different colors.

18. The system of claim 14, wherein the memory device stores pre-set applications for controlling the power control system.

19. The system of claim 14, wherein the sets of LEDS in the fixture is connected to a single printed circuit board assembly.

20. The system of claim 19, wherein the single printed circuit board assembly includes multiple connectors for connecting additional fixtures.

21. A multi-channel power control system, comprising:
a power supply module for converting alternating current into direct current;
a current limiter module for receiving and restricting the direct current output of the power supply module;
one or more DC powered devices connected to the current limiter module, the one or more DC powered devices having at least a first channel and a second channel for providing DC power;
a power control module, the current limiter module connected between the power supply module and the power control module, the power control module comprising:
a memory device; and
a processor, coupled to the memory device, configured to individually control the first and second channels of the one or more DC powered devices.

22. The system of claim 21, further comprising:
a wireless module communicatively coupled to the control module; and
a user controller, wirelessly connected to the wireless control module, configured to:
adjust settings on the one or more DC powered devices;
program applications for controlling one or more DC powered devices;
receive data from one or more sensors connected to the one or more power control modules or directly from the power distribution module.

23. The system of claim 22, wherein the one or more sensors wirelessly connected to the wireless module.
